(19) United States
(12) Patent Application Publication
(10) Pub. No.: US 2007/0276707 A1
(43) Pub. Date: Nov. 29, 2007

(54) Tour event clearinghouse system and method for interaction with retail travel systems

(76) Inventors: Charles E. Collopy, Chicago, IL (US); David E. Collins, Plymouth, MN (US)

Correspondence Address: WALLENSTEIN & WAGNER, LTD., 311 SOUTH WACKER DRIVE, 53RD FLOOR, CHICAGO, IL, 60606, US

(21) Appl. No.: 11/441,282

(22) Filed: May 25, 2006

(51) Int. Cl. G06Q 10/00

(52) U.S. Cl. 705/5

(57) ABSTRACT

A method for distributing event tickets for events operated by a plurality of operators ordered through a retail travel website includes several steps. Operator account information for each of the operators to establish operator accounts is received at a clearinghouse central computer. Event information for each of the events is received at the clearinghouse computer, and the information is made available from the clearinghouse computer. A purchase request to purchase an event ticket is received at the retail travel website. An electronic communication is transmitted to a customer computer, producing a printable encoded electronic ticket. A printed encoded portion of the printed ticket is scanned at an event location. A request to validate the authenticity of the ticket is received at the clearinghouse computer. The ticket is then identified as used in the clearinghouse computer to prevent the ticket from being used again.

### CROSS-REFERENCE TO RELATED APPLICATIONS

None.

### FEDERALLY SPONSORED RESEARCH OR DEVELOPMENT

None.

### TECHNICAL FIELD

The invention relates generally to a tour event ticket distribution system, and more specifically, to a clearinghouse system and method for interacting with tour event operators and retail travel websites.

### BACKGROUND OF THE INVENTION

The nationwide market for events and attractions consists of operators that sell tours and other events to individuals, groups, and families. Currently, many customers who wish to purchase an operator's event will do so via a vendor's website, including retail travel websites such as Travelocity, Alcatraz, Expedia, etc. When this transaction occurs, the vendor charges the customer for the event. The customer then prints a ticket voucher for the event. When the customer finally arrives at the operator of the event, the customer presents the voucher to the operator and is granted admission to the event. Unfortunately, the operator faces many problems because of this ticket system. First, the operator must collect all of the tickets, sort them by vendor, calculate the total, generate an invoice to the vendor, and mail the tickets with the invoice back to each vendor. For medium and large sized operators, this can become a burdensome task. In addition, since the tickets are different from each vendor and not electronically validated, the burden of validating tickets falls on the operator.

U.S. Pat. No. 6,067,532 provides a method for redistributing, purchasing, or selling tickets on the secondary market. The method utilizes a central database at a ticket server to connect individual sellers with individual buyers in a manner that prevents both parties from being deceived or scammed. However, the ticket server is designed to interact directly with individual sellers and customers, and is not adapted to interact directly with a plurality of event operators and retail websites for targeted marketing and wide distribution of tickets. Additionally, many tickets, particularly many types of tour event tickets, have no secondary market. Thus, the disclosed method is not effective for distributing such tickets. Further, the disclosed method provides no process for requesting authentication of the tickets from another entity, and the burden of authentication still falls on the operator. Still further, the only means for preventing re-use of the ticket are preemptive in nature, such as mailing the original ticket to the system manager, deactivating the authorization on the ticket (barcode, magnetic stripe, etc.), and informing the arena not to accept the ticket. Thus, tickets must be purchased a significant time prior to the start of the event.

U.S. Patent Application Publication No. 2003/0236736 discloses an electronic exchange and method for trading permanent seat licenses, event tickets, and contingent event tickets, where ticket holders can post offers to sell the tickets and ticket holders can place bids to buy the tickets. Like U.S. Pat. No. 6,067,532, the exchange and method described in this application deal primarily with connecting individual sellers with individual buyers. Thus, the exchange and method are not adapted to interact directly with a plurality of event operators and retail websites for targeted marketing and wide distribution of tickets. Additionally, while the application provides for printing a barcode, it provides no process for requesting authentication of a ticket from another entity, and the burden of authentication still falls on the operator. This problem also requires tickets to be purchased a significant time prior to the start of the event.

U.S. Patent Application Publication No. 2003/0069829 discloses a public auction system and method for use with a virtual ticket device, which can be a PDA or similar device or may be a dedicated virtual ticket device. The system contains an electronic ticket control system associated with the public facility or venue, which can transmit a virtual ticket to the virtual ticket device and can also host auctions for selling tickets, memorabilia, and other items. However, because the ticket control system is associated only with the single venue and because the auctions hosted by the system typically involve individual buyers and sellers, the system and method are not adapted to interact directly with a plurality of event operators and retail websites for targeted marketing and wide distribution of tickets. Additionally, authentication is performed by checking authenticity with the local electronic ticket control system associated with the venue, and not with a large central system dealing with multiple operators.

The present invention is provided to solve the problems discussed above and other problems, and to provide advantages and aspects not provided by prior ticket distribution systems of this type. A full discussion of the features and advantages of the present invention is deferred to the following detailed description, which proceeds with reference to the accompanying drawings.

### SUMMARY OF THE INVENTION

A method for distributing event tickets for events operated by a restrictive plurality of operators ordered through a retail travel website includes several steps. Operator account information for each of the plurality of operators to establish an operator account for each of the plurality of operators is received at a clearinghouse central computer. Event information for each of the events from the operators is received at the clearinghouse central computer, and the event information is made available from the clearinghouse central computer. A purchase request to purchase an event ticket is received at the retail travel website. An electronic communication is transmitted to a customer client computer. The electronic communication produces a printable encoded electronic event ticket. The printable encoded electronic event ticket is printed at the customer client computer to create a printed event ticket. A printed encoded portion of the printed event ticket is scanned at an event location associated with the event ticket. An authenticity request to validate the authenticity of the printed event ticket is received at the clearinghouse central computer. The event ticket is then identified as used in the clearinghouse central computer to prevent the event ticket from being used again.

According to one aspect of the invention, an invoice report in connection with the event ticket is transmitted from the clearinghouse central computer.

According to another aspect of the invention, a charge amount due to the clearinghouse from the operator is calculated based on a ticket price charged for the event ticket. Additionally, an automatic debit against the operator account corresponding to the charge amount is generated. Further, a portion of proceeds received as a result of the purchase request is paid to the operator associated with the event ticket.

According to another aspect of the invention, the event information is transmitted from the clearinghouse central computer to the retail travel website, and then transmitted from the clearinghouse central computer from the retail travel website to the customer client computer. The purchase request is transmitted from the customer client computer to the retail travel website, and then transmitted from the retail travel website to the clearinghouse central computer.

According to another aspect of the invention, the event information is made available from the clearinghouse central computer to a plurality of retail travel websites.

According to another aspect of the invention, the event information includes at least one of the following: event title information, event admission policy information, ticket price information, ticket availability information, event date/time information, event description information, event location information, seating information, illustrative or promotional photographs or logos, and any special information or instructions.

According to another aspect of the invention, payment is received by the retail travel website in connection with the purchase request.

According to another aspect of the invention, the operator account information includes at least one of the following: operator name information, operator location information, operator financial information, user identification information, operator contact information, and operator description information.

According to another aspect of the invention, the event information is made available by creating a database of event information at the clearinghouse central computer and permitting access to the database by the retail travel website via XML interface.

The present invention also provides a system for interaction with an event operator and a retail travel website. The event operator operates an event and has an operator computer, and the retail travel website has a vendor computer. The system includes a clearinghouse central computer connected to the operator computer, the vendor computer, and at least one customer client computer. The clearinghouse central computer has a memory containing an operating system and a clearinghouse system. The clearinghouse system includes several code segments. A first code segment receives operator account information for the event operator to establish an operator account for the event operator. A second code segment receives vendor account information for the retail travel website to establish a vendor account for the retail travel website. A third code segment for makes available event information about the event to the retail travel website. A fourth code segment for receives a purchase request to purchase an event ticket for admission to the event. A fifth code segment transmits an electronic communication to the customer client computer. The electronic communication produces an encoded electronic event ticket, which is printable to create a printed event ticket. A sixth code segment receives an authenticity request from the event operator to validate the authenticity of the printed event ticket. A seventh code segment transmits a validation signal to the event operator if the printed event ticket is valid. An eighth code segment identifies the event ticket as used to prevent the event ticket from being used again.

According to one aspect of the invention, the event is a tour event, and the event operator is a tour event operator.

According to another aspect of the invention, the computer is further connected to a plurality of event operators, each operating an event, and a plurality of retail travel websites. The third code segment further makes available event information about the event operated by each of the plurality of event operators to the plurality of retail travel websites.

According to another aspect of the invention, the clearinghouse system further includes a code segment for mating the event operator with the retail travel website through the clearinghouse central computer. A rate structure is defined between the retail travel website and the event operator during the act of mating.

According to another aspect of the invention, the clearinghouse system further includes a code segment for calculating a charge amount to be charged to the event operator and a charge amount to be charged to the retail travel website, based on a ticket price charged for the event ticket. In one embodiment, the clearinghouse system further includes a code segment for generating an automatic debit against the operator account corresponding to the charge amount.

The present invention further provides a method for operating a clearinghouse, having a clearinghouse central computer, for distributing event tickets for an event operated by an operator and ordered through a retail travel website. The method includes several steps. Operator account information for the operator is received to establish an operator account for the operator. Event information about the event is made available to the retail travel website. A purchase request to purchase an event ticket is received. An electronic communication is transmitted to a customer client computer, and the electronic communication produces an encoded electronic event ticket that is printable to create a printed event ticket. An authenticity request is received from the operator to validate the authenticity of the printed event ticket. A validation signal is transmitted to the operator if the printed event ticket is valid. The event ticket is then identified as used to prevent the event ticket from being used again.

According to one aspect of the invention, a charge amount due to the clearinghouse from the operator is calculated based on a ticket price charged for the event ticket.

According to another aspect of the invention, an automatic debit is generated against the operator account corresponding to the charge amount.

Other systems, methods, features, and advantages of the present invention will be, or will become, apparent to one having ordinary skill in the art upon examination of the following drawings and detailed description. It is intended that all such additional systems, methods, features, and advantages included within this description, be within the scope of the present invention, and be protected by the accompanying claims.

### BRIEF DESCRIPTION OF THE DRAWINGS

To understand the present invention, it will now be described by way of example, with reference to the accompanying drawings in which:

FIG. 1 is a schematic view of one embodiment of a ticket distribution system of the present invention;

FIG. 2 is a schematic view of one embodiment of a clearinghouse central computer of the present invention;

FIG. 2A is a schematic view of a computer of the present invention;

FIG. 3 is a screen shot of one embodiment of a pricing entry screen for an all-day general admission event according to the present invention;

FIG. 4 is a screen shot of one embodiment of a pricing entry screen for a time-specific general admission event according to the present invention;

FIG. 5 is a screen shot of one embodiment of a pricing entry screen for a time-specific assigned-seating event according to the present invention;

FIG. 6 is a flowchart illustrating a portion of a method for operating a ticket distribution system of the present invention;

FIG. 6A is a continuation of the flowchart of FIG. 6;

FIG. 7 is a flowchart illustrating another portion of the method for operating the ticket distribution system of the present invention;

FIG. 8 is a flowchart illustrating a method for calculating and charging an operator a charge amount in connection with the method for operating the ticket distribution system of the present invention;

FIG. 9 is a flowchart illustrating a method for calculating and charging a vendor a charge amount in connection with the method for operating the ticket distribution system of the present invention;

FIG. 10 is a screen shot of one embodiment of an event entry screen according to the present invention;

FIG. 11 is a screen shot of another event entry screen according to the present invention;

FIG. 12 is a screen shot of one embodiment of an operator account creation screen according to the present invention;

FIG. 13 is a screen shot of one embodiment of a vendor account creation screen according to the present invention;

FIG. 14 is a screen shot of one embodiment of an operator mating screen according to the present invention;

FIG. 15 is a screen shot of one embodiment of a vendor mating screen according to the present invention;

FIG. 16 is a screen shot of one embodiment of an event information screen according to the present invention; and

FIG. 17 is a screen shot of one embodiment of a shopping cart screen according to the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

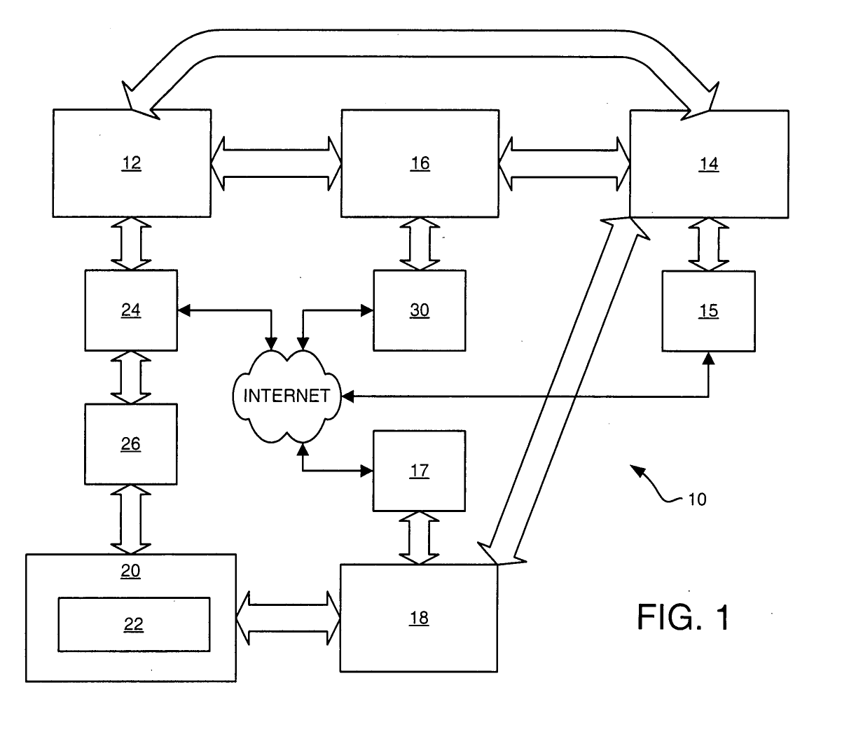

The present invention provides a ticket distribution system 10 and a method for distribution of tickets utilizing the ticket distribution system 10. The ticket distribution system 10 is illustrated generally in FIG. 1, and contains or involves one or more event operators 12, one or more vendors 14, and a clearinghouse 16. The ticket distribution system 10 generally operates to distribute a ticket 20, for an event managed or conducted by the operator 12, from the vendor 14 to a customer 18 through the clearinghouse 16. The ticket distribution system 10 includes several computers. The clearinghouse 16 has a clearinghouse computer 30, the operator 12 has an operator computer 24, the vendor 14 has a vendor computer 15, and the customer 18 has a customer client computer 17. The system and method, and certain variations thereof, are described in more detail below.

The ticket distribution system 10 can be used to distribute tickets or ticket vouchers 20 for any a variety of different events (also referred to as attractions), including, without limitation, sporting and athletic events; theatre, operas, concerts, dinner shows, and other live performances; films; parties and other social events; and tour events. In one embodiment, the ticket distribution system 10 is used to distribute tickets 20 to tour events, which category includes not only traditional organized tours, cruises, and sightseeing events, but also recreational transportation rental, transportation passes, excursions, admissions to historical sites, and other similar tourist activities and events. For example, a non-exhaustive list of tour events contemplated herein includes: bus tours, segway tours, skyscraper tours, day tours, motorcycle rental, hot air balloon rides, helicopter tours or rides, bike tours, airplane tours or rides, horseback tours or rides, jeep tours, combo tours, dinner boats, boat tours, water taxis, public transportation passes, bulk activity passes, public attractions, amusement parks, theme parks, water parks, fairs, zoos, museums, exhibitions, ski lifts and resorts, weddings (both with and without simultaneous divorce), public performances, and recreational lessons and activities such as surfing, scuba diving, skydiving, hang gliding, parasailing, skiing, snowboarding, and other similar activities, as well as equipment rental for such activities.

The tickets 20 distributed through the ticket distribution system 10 can be printable electronic tickets 20. Electronic tickets 20 are electronically transmitted via email, downloading, or other electronic transmission, and may be printed or otherwise tangibly reproduced by the consumer 18 a number of times. Accordingly, the ticket distribution system 10 provides a means for quickly and reliably authenticating tickets 20, described in greater detail below, which is particularly advantageous for events utilizing electronic tickets 20. Alternately, the ticket distribution system 10 may be configured to distribute traditional paper tickets.

Regardless of the form of the tickets 20, each ticket 20 can be individually encoded with a scannable printed encoded portion 22. Generally, the printed encoded portion 22 is a barcode 22 or other similar encoding means. The barcode 22 may contain encoded ticket identification information, described below, including a ticket identification number. The barcode 22 may also contain other encoded information, such as information to describe whether the barcode 22 is being scanned from a ticket voucher 20 or an operator report. The ticket identification number may further be printed in human-readable format proximate the barcode 22, to permit hand-entry instead of scanning. The ticket 20 may contain additional information other than the ticket identification information, but such additional information may not be necessary.

The ticket distribution system 10 may also be used to issue a “super-voucher,” which is a single ticket 20 granting admission to two or more people. The super-voucher may contain several barcodes 22, so that each admission has a separate barcode 22. However, the super-voucher may alternately have a single barcode 22 associated with all admissions contained on the ticket. The super-voucher is purchased and processed in the same manner as a normal ticket 20.

Each event is operated, managed, conducted, or otherwise controlled by an operator 12. In many instances, a single operator 12 may operate a number of different events. The ticket distribution system 10 is designed to interact with a large number of operators 12, each offering event tickets 20 for one or more events. In one embodiment, the operators 12 are tour operators 12, offering tickets 20 to tour events. The operator 12 has an operator computer 24 that is connected to the Internet and may contain one or more applications 13 to interface with other computers within the ticket distribution system 10, which allows the operator 12 to electronically transmit and receive information to and from the clearinghouse central computer 30 and other entities. The operator computer 24 has a scanner 26 for scanning the printed encoded portion 22 of the ticket 20. The scanner 26 can be a tethered optical scanner 26 for scanning a barcode 22 or similar encoding medium. In other embodiments, the scanner 26 may be different, and generally, the scanner 26 is adapted to the particular encoding means used on the ticket 20. In one embodiment, a barcode 22 of a ticket 20 can be scanned at the operator computer 24, and the ticket 20 can be immediately verified through communication between the operator computer 24 and the clearinghouse 16, as described below.

The ticket distribution system 10 is also designed to interact with a large number vendors 14 to offer tickets 20 to a large number of potential customers. In one embodiment, most vendors 14 are retail websites 14, which offer retail goods and services over the Internet, particularly retail travel websites 14, which offer travel tickets and packages, including plane tickets, hotel reservations, car rental, cruise tickets, etc. Retail travel websites 14 are particularly advantageous for use with the ticket distribution system 10 and method, because a large proportion of the users of such websites are tourists. Other entities may be vendors 14 as well, including, for example, travel agents or agencies. The vendor 14 has a vendor computer 15 that is connected to the Internet and may contain one or more applications 13 to interface with other computers within the ticket distribution system 10, which allows the vendor 14 to electronically transmit and receive information to and from the clearinghouse central computer 30, the customer computer 17, and other entities.

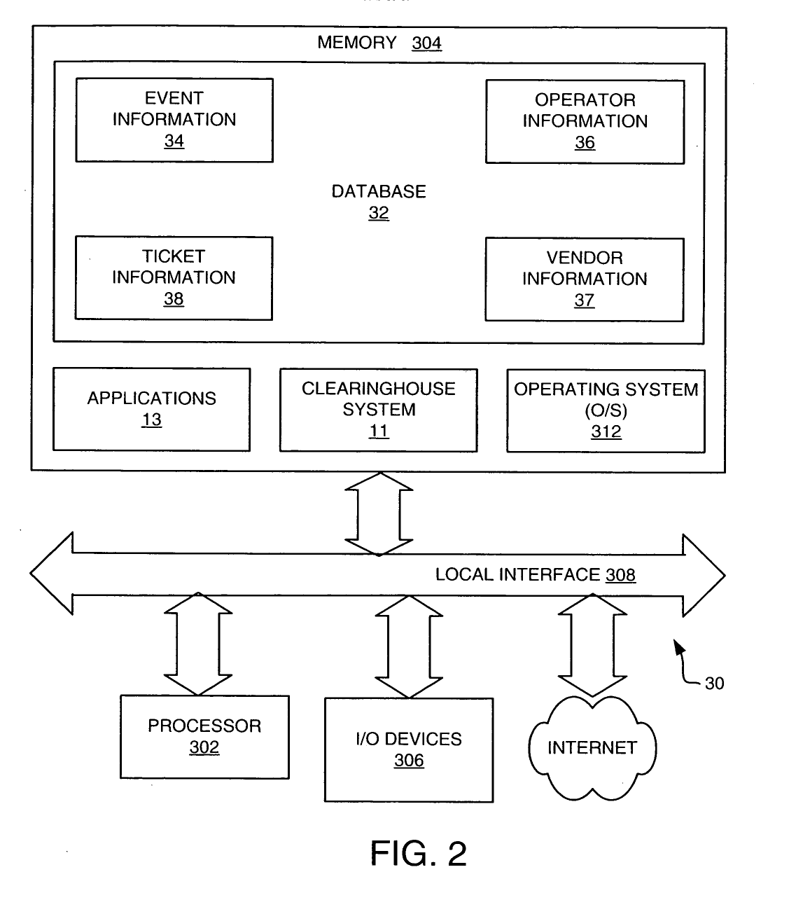

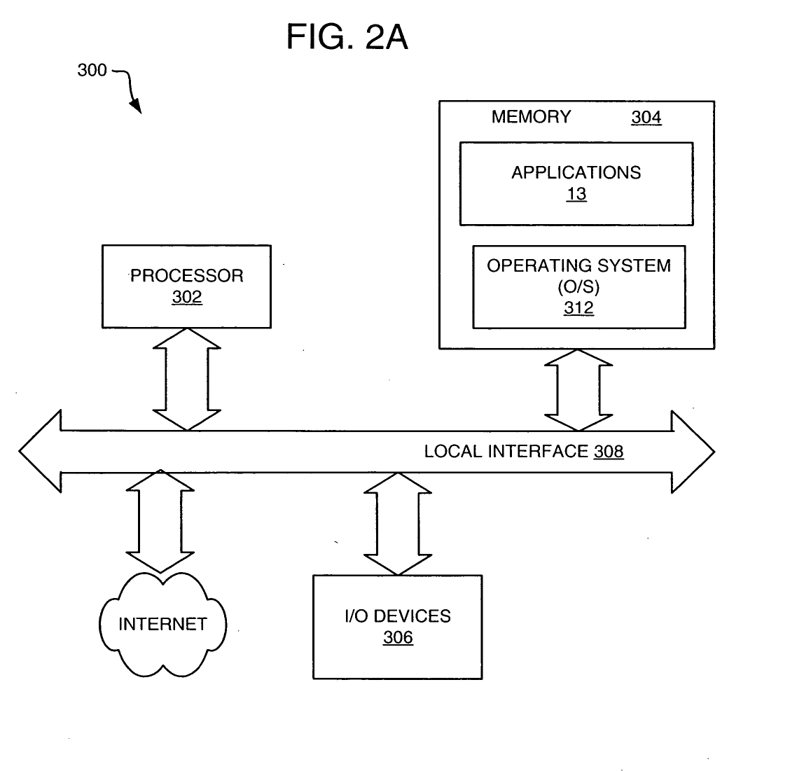

The clearinghouse 16 acts as a “hub” for many of the transactions and interactions between the operators 12 and the retail websites 14 in the ticket distribution system 10. The clearinghouse 16 has a clearinghouse central computer 30, illustrated in FIG. 2, which communicates with both the operators 12 and the retail websites 14, sending and receiving information, as described below. Additionally, in one embodiment, the memory 304 of the clearinghouse central computer 30 contains a database 32, as well as the clearinghouse system 11, which may be implemented in one or more applications 13. The database 32 stores information from the operators 12, vendors 14, and customers 18, including, among other types of information, event information 34, operator account information 36, vendor information 37, and ticket information 38. The event information 34 stored in the database 32 includes one or more of the following: event title information, event admission policy information, ticket price information, ticket availability information, event date/time information, event description information, event location information, seating information, illustrative or promotional photographs or logos, and any special information or instructions. The operator account information 36 (also referred to as “operator information”) includes one or more of the following: operator name information, operator location information, operator financial information, user identification information, operator contact information, and operator description information. The vendor information 37 includes one or more of the following: vendor name information, vendor location information, vendor financial information, user identification information, vendor contact information, and vendor description information. The ticket information 38 includes information about the individual tickets purchased through the ticket distribution system 10, such as: customer identification information, ticket identification information, ticket description information, ticket type information, admission information, and sale information. The above lists are not intended to be exhaustive, and may include other similar information. These types of information will be discussed in greater detail below. As discussed below, certain operator information 36 and event information 34 is made available to vendors 14 to facilitate matching between operators 12 and vendors 14, as well as to enable customers 18 to search events. The database 32 in the clearinghouse central computer 30 can be accessible to the vendors 14 through webpages and/or XML data interfacing. Similarly, certain vendor information 37 in the database 32 is made available to operators 12 to facilitate matching.

Persons authorized to access the ticket distribution system 10 through a computer are generally referred to as “system users.” System users perform such actions as entering or editing information, scanning barcodes 22, searching for and mating with operators 12 or vendors 14, processing returns, and nearly any other manual actions which require computer access. Each system user is given a username and a password, and is designated as an “administrator,” a “manager,” or a “user,” each having different levels of access to the ticket distribution system 10. The clearinghouse 16 and each operator 12 and vendor 14 have at least one system user each, and must each have one administrator. Administrators have the highest level of access, and can access and perform any necessary tasks within the system 10 on behalf of the entity with which the administrator is associated. The clearinghouse 16 and each operator 12 and vendor 14 may also each have a number of managers or users. Managers have intermediate levels of access, and can typically perform most tasks within the ticket distribution system 10, but are precluded from the highest levels of access. Users have the lowest access levels, and typically do not have the ability to edit content within the ticket distribution system 10. Each operator 12 and vendor 14 can add or modify its own list of system users, and the clearinghouse 16 can also add or modify the system users for the operators 12 and vendors 14, along with its own system users. Generally, as used herein, system users affiliated with the operator 12, vendor 14, and clearinghouse 16 may be referred to as “operator users,” “vendor users,” and “clearinghouse users,” respectively.

Each customer 18 has a customer client computer 17 that is connected to the Internet and may contain one or more applications 13 to interface with other computers within the ticket distribution system 10, allowing the customer 18 to electronically transmit and receive information to and from the vendor computer 15 and other entities.

FIG. 2A is a block diagram of a computer 300. The computer may be the clearinghouse central computer 30, the operator computer 24, the vendor computer 15, or the customer client computer 17. The computer 300 includes a memory element 304. The memory element 304 includes a computer readable medium for implementing the clearinghouse system 11 and/or other applications 13 within the ticket distribution system 11 and method. FIG. 2 is a block diagram depicting one embodiment of the clearinghouse central computer 30.

The ticket distribution system 10 includes a clearinghouse system 11 and one or more applications 13 that can be implemented in software, firmware, hardware, or a combination thereof. In one mode, the clearinghouse system 11 and/or other applications 13 are implemented in software, as one or more executable programs, and are executed by one or more special or general purpose digital computer(s), such as a personal computer (PC; IBM-compatible, Apple-compatible, or otherwise), personal digital assistant, workstation, minicomputer, or mainframe computer. Therefore, computer 300 may be representative of any computer in which the clearinghouse system 11 and/or other applications 13 reside or partially reside.

Generally, in terms of hardware architecture, as shown in FIG. 2A (and equally applicable to the clearinghouse computer 30 of FIG. 2), the computer 300 includes a processor 302, memory 304, and one or more input and/or output (I/O) devices 306 (or peripherals) that are communicatively coupled via a local interface 308. The local interface 308 can be, for example, but not limited to, one or more buses or other wired or wireless connections, as is known in the art. The local interface 308 may have additional elements, which are omitted for simplicity, such as controllers, buffers (caches), drivers, repeaters, and receivers, to enable communications. Further, the local interface may include address, control, and/or data connections to enable appropriate communications among the other computer components.

Processor 302 is a hardware device for executing software, particularly software stored in memory 304. Processor 302 can be any custom made or commercially available processor, a central processing unit (CPU), an auxiliary processor among several processors associated with the computer 300, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. Processor 302 may also represent a distributed processing architecture such as, but not limited to, SQL, Smalltalk, APL, KLisp, Snobol, Developer 200, MUMPS/Magic.

Memory 304 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 304 may incorporate electronic, magnetic, optical, and/or other types of storage media. Memory 304 can have a distributed architecture where various components are situated remote from one another, but are still accessed by processor 302.

The software in memory 304 may include one or more separate programs. The separate programs comprise ordered listings of executable instructions for implementing logical functions. In the clearinghouse central computer 30, the software in memory 304 includes the clearinghouse system 11 and/or other applications 13 in accordance with the present invention, and a suitable operating system (O/S) 312. A non-exhaustive list of examples of suitable commercially available operating systems 312 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system 312 essentially controls the execution of other computer programs, such as the clearinghouse system 11, and provides scheduling, input-output control, file and data management, memory management, and communication control and related services.

The clearinghouse system 11 may also utilize some or all of the OpenTravel™ Alliance (OTA) interfacing protocols and/or standards. The OTA uses Web Services Description Language (WSDL) in XML format. The OTA schema and interfacing are described in at least “Project Team/Schema Proposal Document, OTA WSDL Publication, Version 0.1,” and “Project Team/Schema Proposal Document, Air Flight Check-In RQ/RS, Version 3.0,” which are public documents and information available from at least OpenTravel Alliance, 1255 23rd Street, NW, Washington, D.C. 20037-1174, (866) 682-1829, and which are incorporated herein by reference. Additional documents describing the OTA schema and interface are available from the OpenTravel Alliance and through the OpenTravel Alliance website.

The clearinghouse system 11 and other applications 13 may contain one or more source programs, executable programs (object code), scripts, or any other entities comprising a set of instructions to be performed. When a source program, the program needs to be translated via a compiler, assembler, interpreter, or the like, which may or may not be included within the memory 304, so as to operate properly in connection with the O/S 312. Furthermore, the software used in the clearinghouse system 11 and/or other applications 13 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

The I/O devices 306 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices 306 may also include output devices, for example but not limited to, output modules for PLCs, a printer, bar code printers, displays, etc. Finally, the I/O devices 306 may further include devices that communicate both inputs and outputs, for instance but not limited to, a modulator/demodulator (modem; for accessing another device, system, or network), a radio frequency (RF) or other transceiver, a telephonic interface, a bridge, and a router.

If the computer 300 is a PC, workstation, PDA, or the like, the software in the memory 304 may further include a basic input output system (BIOS) (not shown in FIGS. 2-2A). The BIOS is a set of essential software routines that initialize and test hardware at startup, start the O/S 312, and support the transfer of data among the hardware devices. The BIOS is stored in ROM so that the BIOS can be executed when computer 300 is activated.

When computer 300 is in operation, processor 302 is configured to execute software stored within memory 304, to communicate data to and from memory 304, and to generally control operations of computer 300 pursuant to the software. The software of the clearinghouse system 11 and other applications, 13 and the O/S 312, in whole or in part, but typically the latter, are read by processor 302, perhaps buffered within the processor 302, and then executed.

When the clearinghouse system 11 and/or other applications 13 are implemented in software, it should be noted that the clearinghouse system 11 and/or other applications 13 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The clearinghouse system 11 and/or other applications 13 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where the clearinghouse system 11 and/or other applications 13 are implemented in hardware, the clearinghouse system 11 and/or other applications 13 can be implemented with any, or a combination of, the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

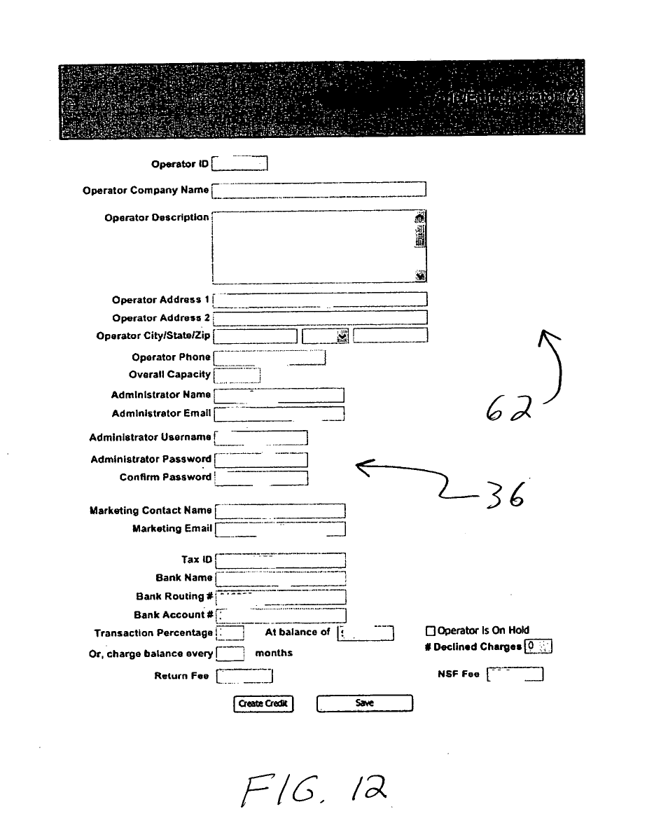

The method of operating the ticket distribution system 10 has several steps. One of the initial steps is establishing an operator account for the operator 12, which can be done at the clearinghouse 16. The operator information 36 is used to create the operator account, which can be done through an operator account creation screen 62. One embodiment of an operator account creation screen 62 is shown in FIG. 12. In one embodiment, the operator information 36 is communicated from the operator 12 to the clearinghouse 16 and is entered into the clearinghouse central computer 30 by a clearinghouse user. After the operator information 36 is entered, the clearinghouse 16 can create the operator account within the clearinghouse central computer 30. Alternately, the clearinghouse 16 may set up a website where an operator 12 can enter the operator information 36 to begin the account creation process. The ticket distribution system 10 provides for the creation of a plurality of operator accounts from a plurality of operators 12 in this manner.

As described above, the operator information 36 includes information about the operator 12, such as: operator name information, operator location information, operator financial information, user identification information, operator contact information, and operator description information. The operator name information identifies the operator 12 by name, using the name of the company, if applicable, as well as a unique operator ID number. The operator location information contains the complete address of the operator 12. The operator contact information contains information such as the operator's phone number and the name and email address of the operator's 12 marketing contact and administrator. The operator description information contains a short written description of the operator's 12 business, as well as the standard capacity for the operator's 12 event(s) and other similar information. The user identification information contains the name, username, password, user status, and entry date of each system user associated with a particular operator 12. The operator financial information includes all necessary financial information for the operator 12, including the number of an active bank account, tax ID number, and information regarding transaction billing percentages, parameters, and procedures, and is discussed in greater detail below. This information may be entered and/or edited by the clearinghouse 16 or the operator 12, depending on the type of information.

The operator financial information entered in the operator account contains a transaction percentage and/or other fees to be charged to the operator and a “charge balance number.” The charge balance is a set dollar amount that will initiate a charge to the operator 12 when the price of issued tickets 20 to the operator 12 reaches the charge balance number, as described below. The operator account also contains a “charge time period.” If the total charges due from the operator 12 within the charge time period do not reach the charge balance number, the total charges will be charged to the operator 12 at the end of the period, as also described below. Further, the operator financial information contains information on any special fees, such as return fees or non-sufficient funds (NSF) fees. Alternately, instead of a transaction percentage, the operator financial information may contain a flat fee amount that is charged to the operator for each purchase, regardless of ticket price.

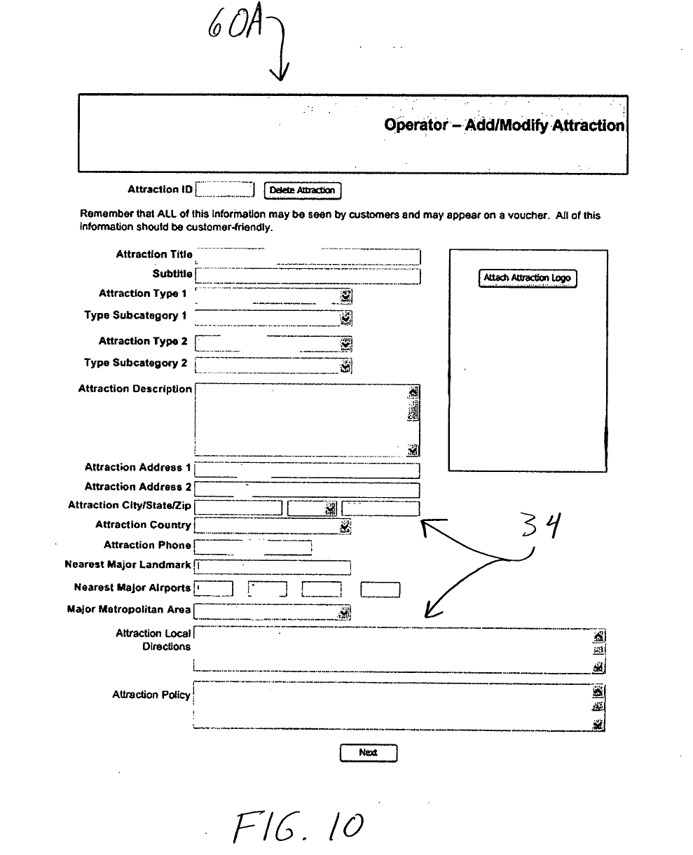

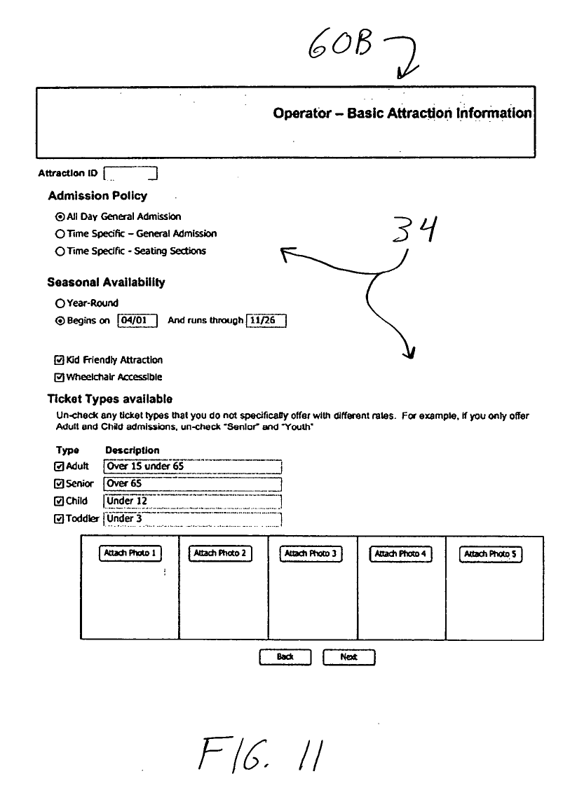

After the operator account is established, an operator user (typically an administrator or manager) can log on to the ticket distribution system 10 through the operator computer 24 to set up event entries in the database 32. To create an event entry, event information 34 is entered by the operator 12 into the database 32 in the clearinghouse central computer 30, such as through an event entry screen 60. FIGS. 10 and 11 show examples of event entry screens 60A,60B. The event information 34 is the primary source of information used by customers 18 and vendors 14 in searching for desirable events. The ticket distribution system 10 provides for the creation of a plurality of event entries from each operator 12 having an operator account.

As described above, the event information 34 stored in the database 32 includes information about the event, such as: event title information, event admission policy information, ticket price information, ticket availability information, event date/time information, event description information, event location information, seating information, illustrative or promotional photographs or logos, and any special information or instructions. The event title information and event description information contain the title and a short description of the event, as well as specific pre-defined categories and subcategories of events into which the event fits, such as those described above. The event admission policy information defines the admissions policy of the event, such as general admission vs. reserved seating, time-specific vs. all-day admission, etc. The event admission policy information also may include different ticket types available, such as adult, child, senior, infant/toddler, etc., as well as qualifications for such types. The ticket price information includes ticket prices for the event, which may be broken down by variables such as event time, ticket type, and seating area, as well as any specialized rate structures. Ticket availability information defines the maximum capacity for each event, and also contains a variable component reflecting the number of tickets 20 purchased, which changes with each purchase. Event date/time information lists the date and time of each showing of the event. Seasonal availability or year-round availability may be defined as well. Seating information reflects the different seating areas or classes for the event, which may be broken down by bulk areas or by individual seats. Logos and/or photographs may be submitted in standard graphic image files (.bmp, .jpg, .gif, etc.). Additionally, the event information may include special information or instructions, such as policies, age limits, directions to reach the event, proximate airports or landmarks, suitability for children, wheelchair accessibility, and any other necessary information. In one embodiment, most of the event information is added to the database 32 of the clearinghouse central computer 30 by the operator 12, typically by the operator administrator. The clearinghouse central computer 30 may check certain event information to ensure that necessary fields have been filled and that certain information (such as phone numbers and zip codes) are correctly formatted.

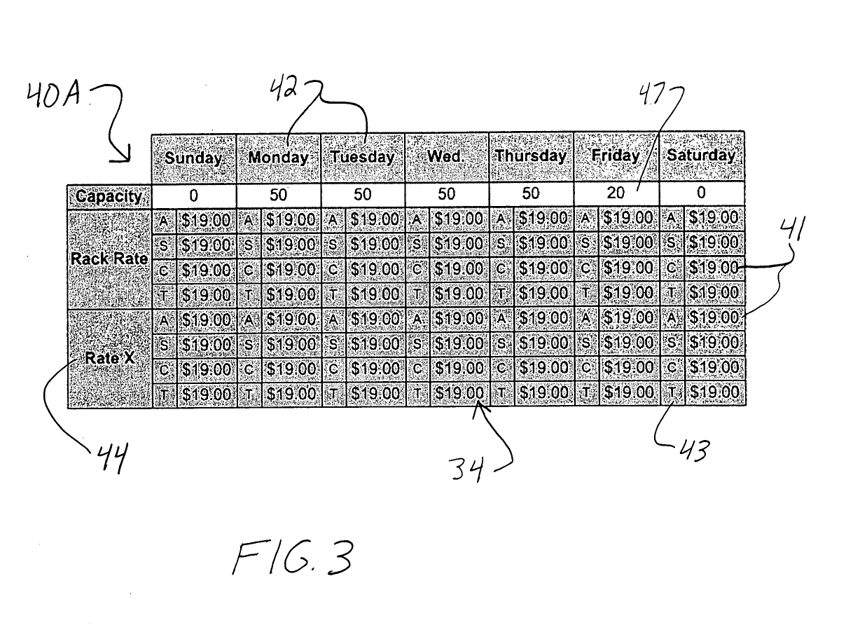

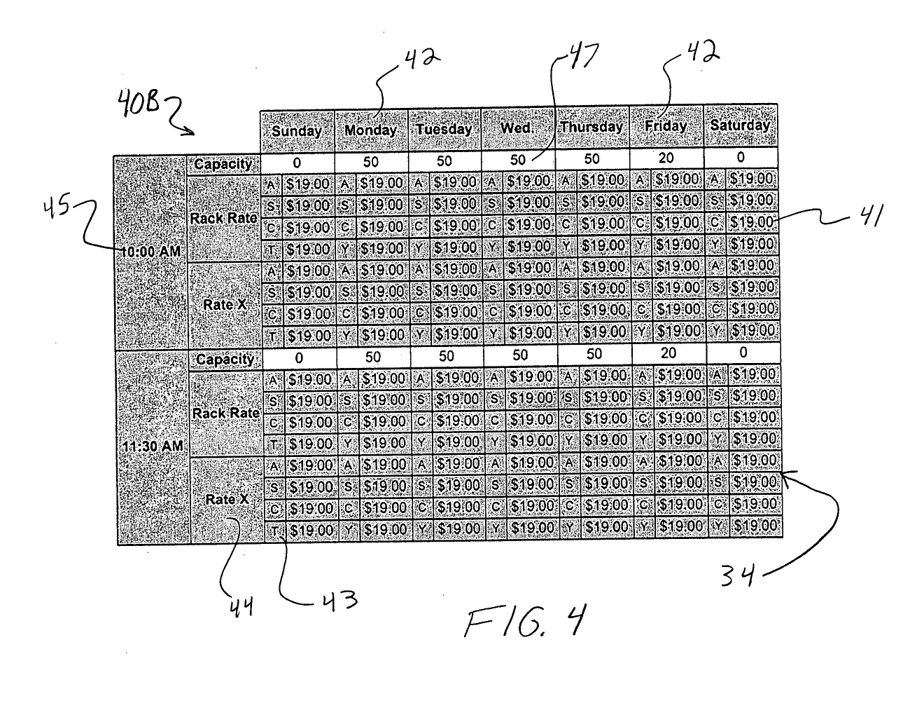

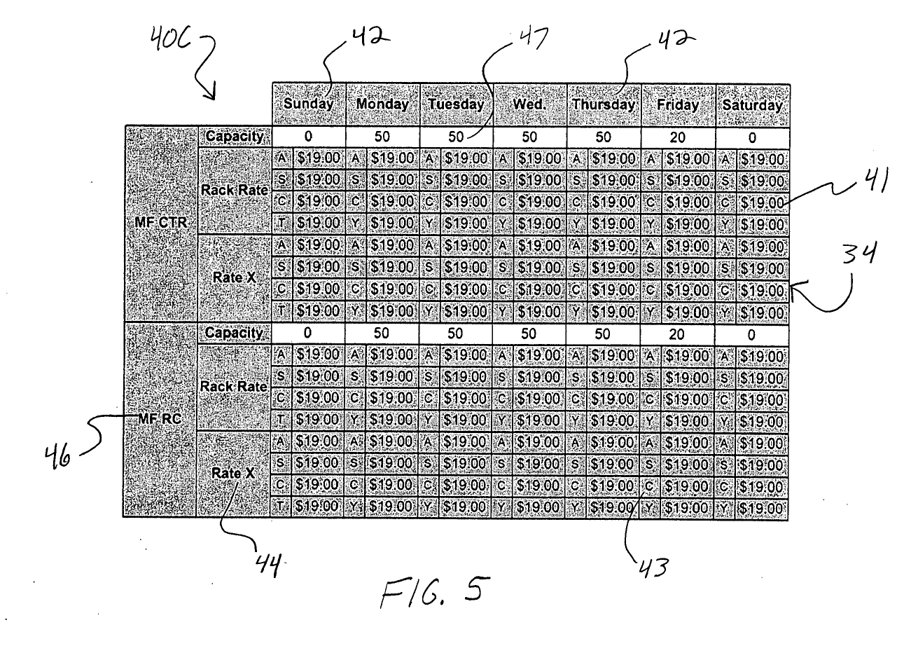

The ticket distribution system 10 provides a detailed pricing entry screen 40 for the operator 12 to enter ticket price information and event time information, as well as certain admission policy information, ticket availability information, and other information. As illustrated in FIGS. 3-5, the pricing entry screen appears in grid format. The ticket prices 41 are generally broken down by day 42, ticket type 43, and rate structure 44. As illustrated in FIGS. 3-5, ticket type information 43 is broken down by adult (“A”), senior (“S”), child (“C”), and toddler (“T”) or youth (“Y”). Additionally, the rate structure 44 is broken down by Rack Rate, which is the price charged at the gate by the operator 12, and Rate X, which may be a different rate charged based on circumstances. The grids for each admission policy also include capacity information 47 for each event showing. The clearinghouse central computer 30 will generate these grids automatically for the appropriate event type and with certain information already filled in, based on information previously provided by the operator. FIG. 3 illustrates the basic pricing entry screen 40A for an all-day general admission event, which do not generally require further breakdown of prices. FIG. 4 illustrates the basic pricing entry screen 40B for a time-specific general admission event. Accordingly, the grid in FIG. 4 is further broken down by event times 45, which can be provided by the operator 12 before entry into the grid. FIG. 5 illustrates the basic pricing entry screen 40C for a time-specific assigned seating event. Accordingly, the grid in FIG. 5 is further broken down by seating sections 46, which can be provided by the operator 12 before entry into the grid. Further, in the case of assigned seating, the ticket distribution system 10 provides fields (not shown) for the operator 12 to specifically define each seating section by section name, specifically-named rows, number of seats per row, and desirability of seating (ranked on a scale of 1-10).

It is understood that an operator 12 will frequently assign the same event times and rates every week during the period when the event is open. Thus, the ticket distribution system 10 provides for the creation of a “base week” pricing and capacity structure, which can be created using the pricing entry screen 40 described above. However, operators 12 may desire to occasionally deviate from the base pricing and capacity structure, such as during a holiday week or a particularly busy season. Accordingly, the ticket distribution system 10 also provides for allowing the operator 12 to override the base pricing structure. In one embodiment, the operator 12 can log into the ticket distribution system 10 and create a specialized pricing structure for a selected week using the pricing entry screen 40 described above. The specialized pricing structure is the applied to the selected week, and the base pricing structure remains applicable to the remaining weeks.

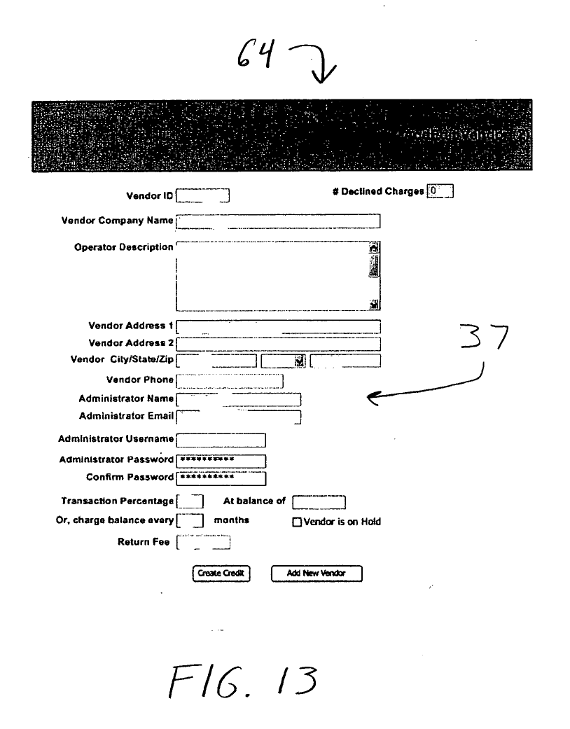

The ticket distribution system 10 further provides for the establishment of a plurality of vendor accounts from a plurality of vendors 14. Vendor account information 37 is used to create each vendor account. Vendor accounts can be created in substantially the same manner as the operator accounts, such as through a vendor account creation screen 64. An example of a vendor account creation screen 64 is illustrated in FIG. 13. In one embodiment, the vendor information 37 is communicated from the vendor 14 to the clearinghouse 16 and is entered into the clearinghouse central computer 30 by a clearinghouse user. After the vendor information 37 is entered, the clearinghouse 16 can create the vendor account within the clearinghouse central computer 30. Alternately, the clearinghouse 16 may set up a website where the vendor 14 can enter the vendor information 37 to begin the account creation process.

As described above, the vendor information 37 includes information about the vendor 14, such as: vendor name information, vendor location information, vendor financial information, user identification information, vendor contact information, and vendor description information. The vendor name information identifies the vendor 14 by name, using the name of the company, if applicable, as well as a unique vendor ID number. The vendor location information contains the complete address of the vendor 14. The vendor contact information contains information such as the vendor's phone number and the name and email address of the vendor's 14 contact and/or administrator. The vendor description information contains a short written description of the vendor's 14 business and other similar information. The user identification information contains the name, username, password, user status, and entry date of each system user associated with a particular vendor 14. The vendor financial information includes all necessary financial information for the operator 12, including and transaction billing percentages, parameters, and procedures. This information may be entered and/or edited by the clearinghouse 16 or the vendor 12, depending on the type of information.

Like the operator financial information, the vendor financial information entered in the vendor account contains a transaction percentage and/or other fees to be charged to the vendor 14 and a charge balance number. The charge balance is a set dollar amount that will initiate a charge to the vendor 14 when the price of tickets 20 issued by the vendor 14 reaches the charge balance number, as described below. The vendor account also contains a charge time period. If the total charges due from the vendor 14 within the charge time period do not reach the charge balance number, the total charges will be charged to the operator 12 at the end of the period, as also described below. Further, the vendor financial information contains information on any special fees, such as return fees or non-sufficient funds (NSF) fees. Additionally, like the operator financial information, the vendor financial information may alternately contain a flat fee amount instead of a transaction percentage, which is charged to the vendor for each ticket 20 sold, regardless of the price of the ticket.

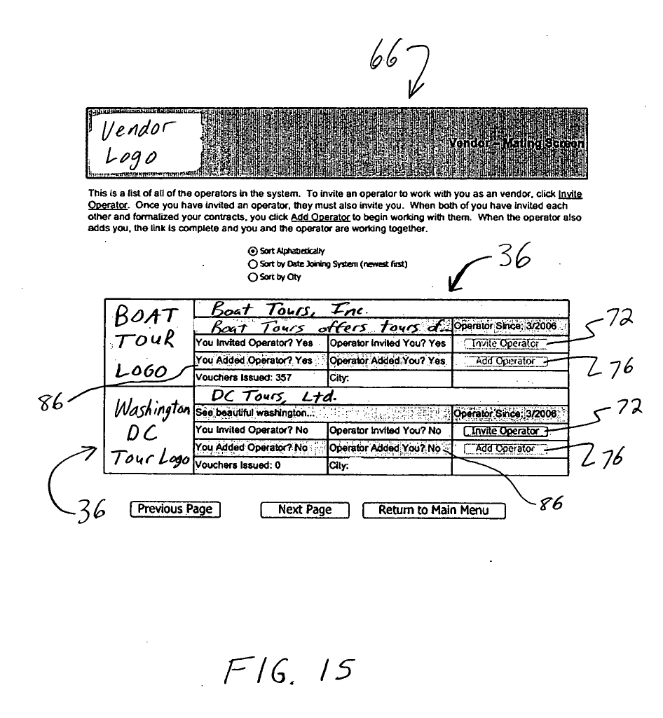

The ticket distribution system 10 provides for making available certain operator information 36 and event information 34 to vendors 14 having vendor accounts. The vendors 14 are able to search this information in the database 32 using a vendor computer 15 and select operators 12 with which a particular vendor 14 desires to establish a relationship. Typically, at least operator name information, operator location information, operator description information, and operator sales information is made available to vendors 14 searching for operators 12, along with the date on which the operator account was established. In one embodiment, this operator information 36 is made available in a condensed and easily viewable format on a vendor mating screen 66 accessible via the Internet. An example of a vendor mating screen 66 is illustrated in FIG. 15.

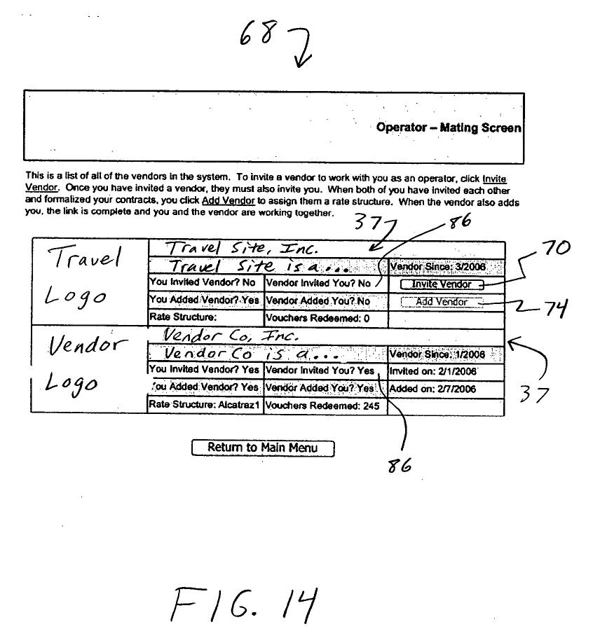

Similarly, certain vendor information 37 is made available to operators 12 having operator accounts, allowing the operators 12 the ability to invite vendors 14 with which a particular operator 12 desires to establish a relationship. Typically, at least vendor name information, vendor description information, vendor rate structure information, and vendor sales information is made available to operators 12 searching for vendors 14, along with the date on which the vendor account was established. As with the operator information 36, this vendor information 37 is made available in a condensed and easily viewable format on an operator mating screen 68 accessible via the Internet. An example of an operator mating screen 68 is illustrated in FIG. 14. As shown in FIGS. 14 and 15, the mating screens 66,68 may also report the status 86 of the mating process, i.e., whether each operator 12 or vendor 14 has been invited or added.

The operator-vendor mating process begins with the mating screens described above. An operator 12 (or vendor 14) initiates the mating process from the mating screen by inviting a vendor 14 (or operator 12) to establish a working relationship. Invitation can be done by clicking an invitation button or link on the mating screen, for example, the button 70 labeled “Invite Vendor,” shown in FIG. 14. If the initial invitation is done by an operator 12, an email is sent from the clearinghouse 16 to the vendor's primary contact, informing the vendor 14 that the particular operator 12 has invited the vendor 14 to work with them. The email also lists contact information for the operator 12, including contact name and phone number. If the vendor 14 wishes to work with the inviting operator 12, the vendor 14 then invites the operator 12 in the same manner, such as by clicking on the button 72 labeled “Invite Operator,” shown in FIG. 15. The vendor invitation causes the clearinghouse 16 to send an email to the operator's primary contact, informing the operator 12 that the vendor would also like to work with them. Similarly as before, the email lists contact information for the vendor 14. The operator 12 and vendor 14 then communicate with each other, using the contact information provided, to reach an agreement regarding rate structure and issue price. The issue price is the price which the vendor 14 pays the operator 12 for the ticket 20. Once an agreement has been reached, the operator 12 can “add” the vendor 14, establishing the operator-vendor relationship from the operator's end. Adding a vendor 14 can be accomplished by clicking on an adding button or link that is accessible only after the invitation, for example, the button 74 labeled “Add Vendor,” shown in FIG. 14 After adding the vendor 14, the operator 12 enters the agreed-upon rate structure and then updates the pricing for the new rate structure for each of the events offered by the operator 12, if necessary. Finally, the vendor 14 can add the operator 12, completing the mating process. Similarly to adding a vendor 12, adding an operator 12 can be accomplished by clicking on an adding button or link, such as the button 76 labeled “Add Operator,” shown in FIG. 15. If the initial invitation is done by a vendor 14, the process works substantially the same as described above, except that the order of the invitation steps are reversed.

After the operator 12 and the vendor 14 have successfully completed the mating process and entered into a business relationship, the ticket distribution system provides for making the event information 34 for the operator 12 available to the vendor 14 for presentation to customers 18 for purchase. In one embodiment, the vendor 14 is a retail website or a retail travel website 14 having its own search capabilities. In this embodiment, the vendor 14 interfaces its own applications 13 with the database 32 at the clearinghouse central computer 30 via XML interfacing. The vendors 14 can integrate the ticket distribution system 10 with their own information systems by way of standard XML calls, such as XML calls for querying matching attractions, issuing vouchers, etc. This allows the vendor 14 to present event information to customers 18 from the database 32. This also allows customers 18 to search for events contained in the database 32 through the vendor's applications 13 by connecting to a vendor computer 15 over the Internet through a customer client computer 17. The customer can then send XML requests to the clearinghouse central computer 30 through the vendor 14. Additionally, since customer search requests are processed through the vendor's applications 13, the vendor 14 may operate or format the process differently, as the vendor 14 prefers.

If the vendor 14 does not have the capability to use XML interfacing, the clearinghouse 16 also provides a graphical user interface (GUI) displayed for the vendor 14 to use to search the database 32 by logging into the ticket distribution system 10 through the vendor computer 15. The GUI screen formats an XML search request using the defined parameters and sends the search request to the clearinghouse central computer 30. The clearinghouse central computer 30 then processes the XML search request and returns an XML response, which is parsed and displayed on the vendor's 14 computer. In either embodiment, the searching can be done by defining fields of event information 34 to be searched, such as event location information, event description information, ticket price information, and other similar information. The search may also define event date/time information, as well as certain special instructions or similar information, such as discounts, wheelchair access, and suitability for children. Further, in either embodiment, the operator 12 mates with a plurality of vendors 14, and the event information 34 of the operator 12 is made available for searching by or through all of the plurality of vendors 14. Similarly, the vendor 14 can mate with a plurality of operators 12, and the event information of all of the plurality of operators 12 is made available to or through the vendor 14.

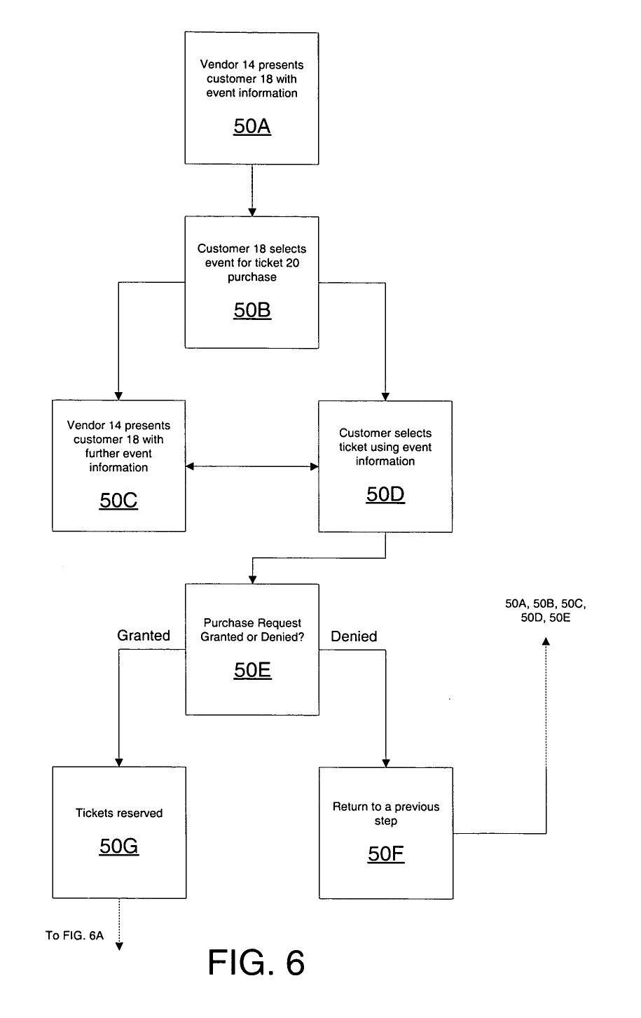

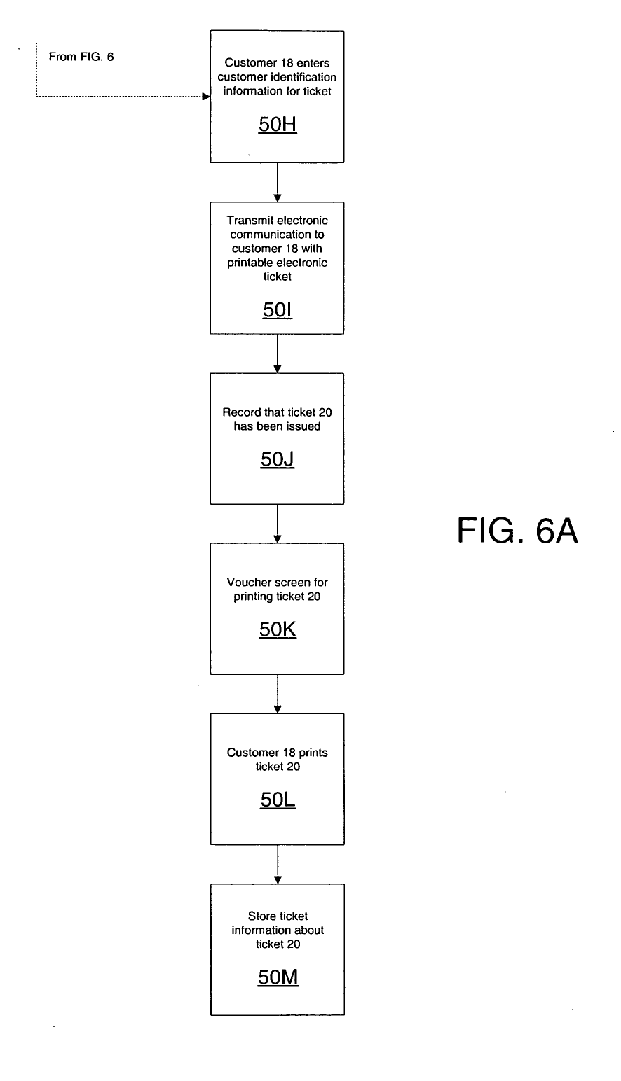

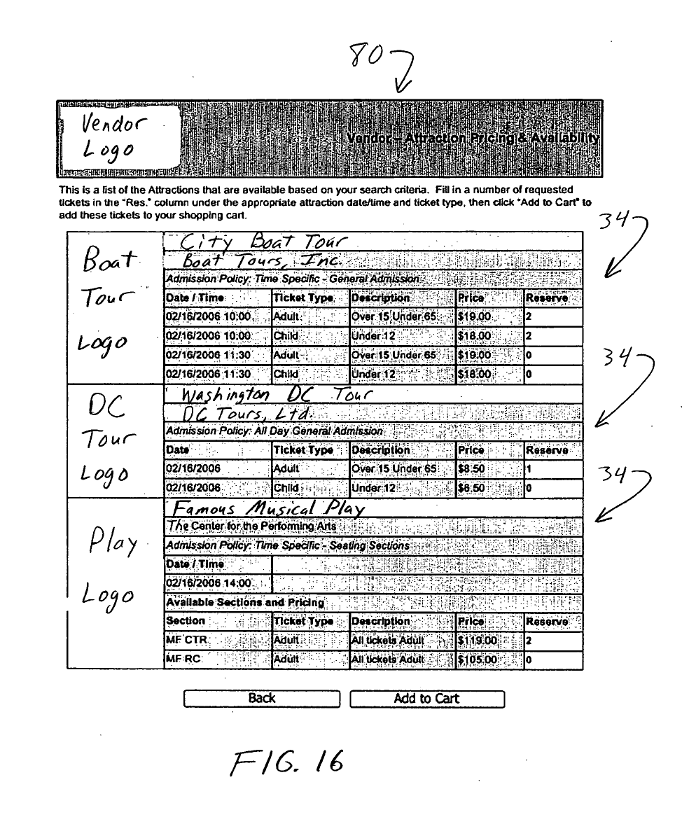

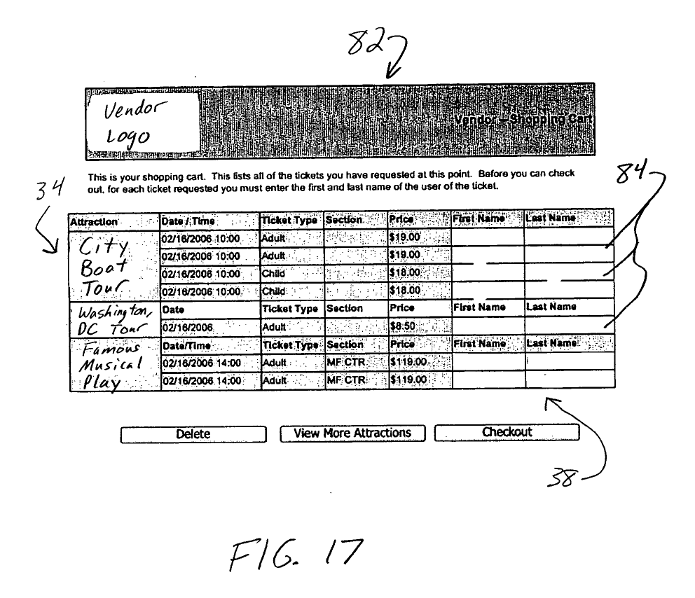

The flowchart in FIGS. 6-6A illustrates one process by which a customer 18 can purchase a ticket 20 from a customer computer 17 through a vendor 14 within the ticket distribution system 10. The process begins with step 50A, where the vendor 14 presents the customer 18 with event information regarding one or more events offered by one or more operators 12. The vendor 14 typically presents such information via an electronic communication which causes a viewable display on the customer computer 17, for example, through an event information screen 80 illustrated in FIG. 16. The event information can be provided to the vendor 14 by the clearinghouse central computer 30. The presentation to the customer 18 can be done after receiving a search request from the customer 18, or can be done automatically by the vendor 14 based on information known about the customer 18 (such as a customer's travel destination). In one embodiment, an event will not be presented to the customer 18 unless at least one ticket 20 for the event is still available for purchase. The customer 18 then selects one or more events/attractions at step 50B, and the vendor 14 can present the customer with further event information, including ticket availability information, event time and date information, and ticket price information at step 50C. If the customer 18 desires to purchase a ticket 20 to the event, the customer 18 can select an event, date, time, number of tickets, and, if applicable, a ticket type (adult, child, etc.) or seating section at step 50D. Steps 50C and 50D may be done in succession, where the vendor 14 presents all relevant information for an event at once. Alternately, steps 50C and 50D may be combined into a series of substeps, for example, where the customer 18 is presented with certain information (such as an event description and available dates) and then presented with additional information (such as event times and ticket prices) after selection of an event and date. The event information screen 80 shown in FIG. 16 both presents event information 34 and allows the customer 18 to select tickets, illustrating how steps 50C and 50D can be simultaneously accomplished. If there are no acceptable tickets 20 available, the customer 18 can return to a previous screen/step. The tickets 20 can be selected for purchase by the well known “add to cart” feature or other similar method. All of the tickets 20 selected for purchase by the vendor 14 can then be viewed by opening a “shopping cart” screen 82. An example of a shopping cart screen 82 is illustrated in FIG. 17.

When the customer identifies acceptable ticket(s) 20 to purchase, the ticket distribution system 10 provides for receiving an electronic purchase request 50E to purchase the ticket(s) 20. The electronic purchase request 50E can be transmitted from the customer 18 and received by the vendor 14, and then transmitted from the vendor 14 and received by the clearinghouse central computer 30. In one embodiment, the tickets 20 are not reserved until step 50E, and can be taken by one customer 18 while in another customer's cart. However, in other embodiments, a ticket 20 may be temporarily reserved by the act of the customer 18 placing the ticket in the cart or otherwise selecting a ticket 20 for which to begin the purchasing process. If, for some reason, one or more selected tickets 20 cannot be reserved or purchased (e.g., lack of availability), the purchase request 50E is denied, and the customer will be returned to a previous screen at step 50F. Otherwise, the purchase request 50E is granted, and the tickets are reserved at step 50G. Before the ticket purchase is complete, the customer can enter customer identification information for each ticket 20, including at least the name of the customer who will be using the ticket, at step 50H. In one embodiment, the ticket distribution system 10 requires customer identification information for each ticket 20 to be entered prior to purchase. The shopping cart screen 82 illustrated in FIG. 17 requires entry of customer names 84 prior to checkout. In the case of a super-voucher, customer identification information for several customers is entered for a single ticket 20. Customer payment information may be entered at step 50F as well. In an alternate embodiment, the purchase request 50E is not transmitted until the customer information has been entered.

Once the purchase request is granted and the ticket or tickets 20 have been purchased, the ticket distribution system 10 provides for transmitting an electronic communication to the customer 18, which produces a printable encoded electronic tour event ticket 20, at step 50I. The electronic communication may comprise, for example, a file that contains the printable ticket 20 (such as a .JPG, .BMP, OR .GIF image or a .PDF file), a script which causes an image of the printable ticket 20 to be displayed, or an email containing an image of the ticket 20 or an attachment containing the ticket 20. In one embodiment, the communication includes a .JPG image of the ticket 20. Also, in one embodiment, the communication is generated by and transmitted from the clearinghouse central computer 30 to the customer computer 17, but alternately, the vendor 14 or the operator 12 may generate and/or transmit the ticket 20 to the customer 18. The clearinghouse central computer 30 also records that the ticket 20 has been issued, affecting the ticket availability information for the event, at step 50J. When the communication is received and opened by the customer 18, the communication may produce a voucher screen at step 50K. At the voucher screen 50K, the printable encoded electronic tour event ticket(s) 20 are displayed in printable format and can be printed by the customer 18 at step 50L. Printed tickets 20 can be used for admission to the event.

Once a ticket 20 is purchased, the database 32 at the clearinghouse central computer 30 stores ticket information 38 about each individual ticket 20, at step 50M. As described above, the ticket information 38 includes such information as: customer identification information, ticket description information, ticket identification information, ticket type information, admission information, and sale information. The customer identification information includes information about the person (or persons, in the case of a super-voucher) who will be using the ticket for admission, such as name, age, address, phone number, and/or other identifying information. The ticket description information can contain portions of event information 34, operator information 36, and vendor information 37, including the operator 12 name and event time and location information. The ticket type information identifies the type of ticket 20 issued, i.e. adult, senior, child, infant, and any other type that may be offered. The admission information describes the type of admission, such as general admission or assigned section, and may also include an assigned or reserved seat number. The sale information includes information about the sale of the ticket, such as the operator 12 and vendor 14 names, the ticket price, and any other information that may be necessary for financial processing or requests for refunds. The ticket identification information can be a number or code that identifies the ticket 20 as unique and is used for authentication purposes. Some of the ticket information 38 is printed on the ticket 20, particularly some customer identification information, ticket type information, admission information, ticket description information, and ticket identification information. In one embodiment, the ticket identification information is contained in the printed encoded portion 22 that is readable only by a specialized apparatus. As described above, in one embodiment the ticket 20 contains only the encoded portion 22, and no other information.

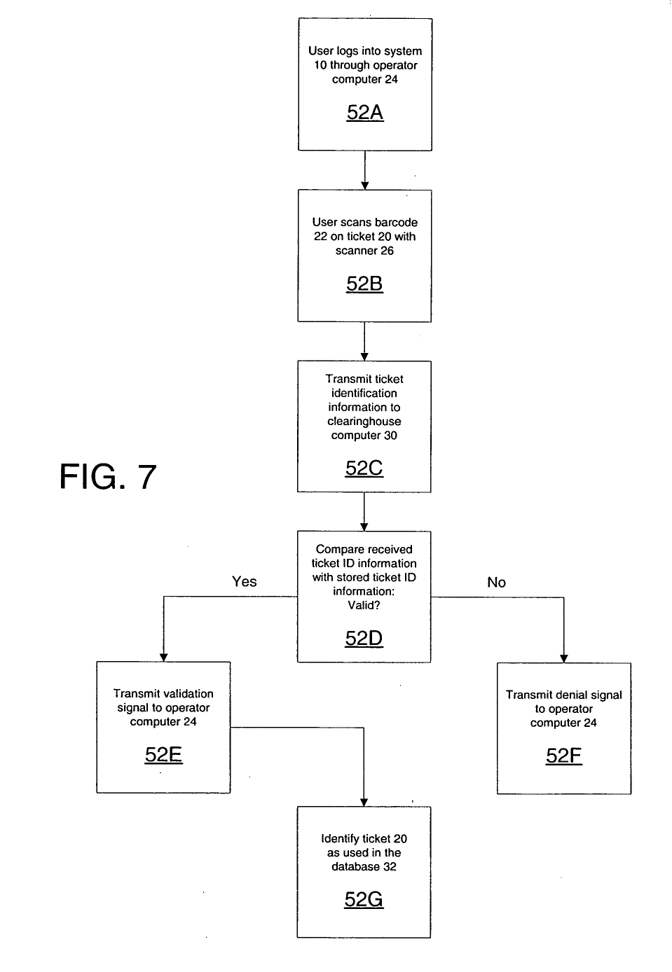

The flowchart in FIG. 7 illustrates one process by which a customer 18 redeems a purchased, printed ticket 20 to gain admission to the event. Additionally, FIG. 1 schematically describes some of the components in the process of FIG. 7. Printed tickets 20 contain a printed encoded portion 22, such as the barcode 22 discussed above that contains encoded ticket identification information. The ticket distribution system 10 provides for scanning the printed encoded portion 22 of the printed ticket 20 on-site at the location associated with the ticket 20. As described above, the operator 12 has an operator computer 24 that is connected to the Internet, which allows the operator 12 to electronically transmit and receive information from the clearinghouse central computer 30. The operator computer 24 has a scanner 26 connected thereto for scanning the printed encoded portion 22 of the ticket 20. In one embodiment, the operator computer 24 and the scanner 26 may be a single device, such as a PDA equipped with a scanner feature. Before scanning the printed encoded portion 22, an operator user logs into the ticket distribution system 10 through the operator computer 24 at step 52A. Once logged in, the operator user can scan the printed encoded portion 22, reading the encoded ticket identification information contained therein, at step 52B. Alternately, the user can enter the ticket identification information by hand at step 52B, if the ticket identification number is printed on the ticket 20. The operator 12 then uses the ticket identification information to authenticate the ticket 20 in real time through the clearinghouse 16.

The ticket distribution system 10 provides for authenticating the ticket 20 through sending an authenticity request to validate the authenticity of the printed ticket 20 and receiving the authenticity request at the clearinghouse central computer 30. The transmission of the authenticity request can be done by XML transmission. To authenticate the ticket 20, the operator computer 24 first transmits the ticket identification information scanned from the printed ticket 20 to the clearinghouse central computer 30, at step 52C. The clearinghouse central computer 30 then compares the ticket identification information received from the operator computer 24 with the ticket identification information stored in the database 32, at step 52D. If the ticket 20 is valid, the clearinghouse central computer 30 transmits a validation signal to the operator computer 24 to notify the operator 12 that the ticket is valid and authentic, at step 52E. The ticket 20 is validated if the received identification information matches the stored information, if the ticket 20 is being used at the correct event, date, and time, and if the ticket 20 has not been previously used or returned. If the ticket 20 is not valid, e.g. if one of the above qualifications is not met, the clearinghouse central computer 30 transmits a denial signal to the operator computer 24 to notify the operator 12 that the ticket 20 is not valid, at step 52F. The operator computer 24 may produce different audible beeps to distinguish a valid ticket 20 from an invalid ticket 20. Additionally, the ticket distribution system 10 provides for identifying the ticket 20 as “used” in the clearinghouse central computer 30 to prevent the ticket 20 from being used again, at step 52G. If a ticket 20 marked as “used” is attempted to be authenticated, the clearinghouse central computer 30 will deny the authentication request and transmit a denial signal to the operator computer 24. Thus, the ticket 20 can be authenticated in real-time through communication with the clearinghouse central computer 30. The authentication process may also involve the operator 12 manually checking the identification of the customer attempting to redeem the ticket against customer identification information printed on the ticket 20. Thus, the clearinghouse central computer 30 may transmit other ticket information along with the validation signal, including customer identification information. Alternately, the operator 12 may have previously stored such ticket information from reading an operator report, as described below.

In one embodiment, the ticket distribution system 10 assigns a status to a ticket 20 depending on the response from the clearinghouse central computer 30. If the ticket 20 is authenticated, the ticket 20 is identified as “Accepted.” If the ticket 20 has already been used, the ticket 20 is identified as “Invalid—Already Used.” If the ticket 20 is valid and unused, but was issued for another operator 12, the ticket 20 is identified as “Invalid—Wrong Operator.” If the ticket identification number is hand-entered, a warning is given to that effect. If the ticket 20 is valid and unused, but was issued for another date or show time, the ticket 20 is identified as such, and a warning is given to that effect. Additionally, in such a case, the operator 12 is given the option to accept the ticket 20 and allow the customer 18 admission to the event, for example, if the event is not filled to capacity. If the ticket 20 is accepted in this manner, an acceptance signal is transmitted to the clearinghouse central computer 30, and, if the ticket 20 was issued for a future date, the clearinghouse 16 releases an additional ticket 20 on that date to replace the used ticket 20.

As mentioned above, the encoded information in the barcode 22 may also contain information regarding the source of the scanned barcode 22, such as a prefix. For example, if the barcode 22 is scanned from a ticket voucher 20, the encoded identification number in the barcode 22 may contain a prefix (e.g., *VOU), and if a barcode 22 is scanned from an operator report, the encoded identification number may contain a different prefix (e.g., *REP). These prefixes are not displayed to the system user, but are logged by the operator computer 24. If a stored barcode 22 has no prefix, the barcode 22 is logged as being entered by hand. Additionally, most tethered scanners 26 typically will automatically add a <Tab> character as a suffix to the scanned barcode 22, to process the barcode 22, as one in the field of barcode processing would understand. Further, the operator computer 24 may display the barcode 22 of the last ticket 20 scanned, the customer name(s) associated with the ticket 20, and the status of the last ticket 20.

The ticket distribution system 10 also provides a process for returning a ticket 20 for a refund. Typically, returns are processed by the vendor 14, but could be processed by the operator 12 or the clearinghouse 16 in some embodiments. First, the ticket identification number is transmitted to the clearinghouse central computer 30 from the vendor 14, along with a request for a return. Next, the clearinghouse central computer 30 determines whether the ticket 20 qualifies for a return. The clearinghouse central computer 30 will deny the request if the ticket 20 has already been returned, the ticket 20 has already been scanned, the ticket 20 was issued from another vendor 14, or if the ticket 20 is past its expected scan date. Otherwise, the clearinghouse central computer 30 will grant the return request, and the vendor 14 can grant the customer 18 a refund. Once the return request is granted, the clearinghouse computer 30 records the ticket 20 as invalid, and any future attempts to the authenticate the ticket 20 will be denied. The clearinghouse computer 30 will also release one item of capacity back into the ticket availability information for the event. Further, the clearinghouse 16 must credit the vendor 14 for the transaction fee for the returned ticket 20, because vendors 14 are generally charged on the issue date of a ticket 20 (described below), and the return date is always after the issue date. Finally, the vendor 14 is charged a return fee, if applicable.

An operator 12 may also receive an operator report from the clearinghouse central computer 30, listing a variety of information. For example, the operator report may contain a list or grid of all the operator's 12 events and pricing therefor. Other operator reports may include sales history for an event, which can be broken down by specified time periods, a list of all the outstanding (un-scanned) tickets 20 for one event or multiple events for the operator 12, or a list of all the tickets 20 scanned in a given day. Still further, an operator report may contain a billing report summarizing the issued prices of issued vouchers for a given date, which can be used both as a predictor of future sales and as an invoice (and may be referred to as an invoice report). The operator report can be downloaded or otherwise electronically transmitted from the clearinghouse 16 to the operator 12 for printing. Additionally, the operator report can be implemented via XML interfacing, through XML calls and responses, for the transfer of data for the report. Accordingly, the ticket distribution system 10 provides both a GUI method and an XML method of obtaining such information.

Another operator report can include a list of all of the ticket vouchers 20 expected to be redeemed on a given day. In one embodiment, the operator report displays a series of barcodes 22 corresponding to the already-purchased tickets 20, each barcode 22 containing an *REP prefix encoded therein as described above. Thus, the operator 12 can scan all of the barcodes 22 on the operator report and the operator computer 24 will identify the scanned barcodes 22 and store the ticket identification numbers. This allows the operator 12 the option of having the operator computer 24 validate tickets 20, rather than going through the clearinghouse central computer 30. However, because tickets 20 can also be validated through the clearinghouse 16, even tickets 20 purchased very close to the event time, after the operator report has already been issued, can still be validated. Further, even if the operator computer 24 validates a ticket 20, a signal can still be sent to the clearinghouse central computer 30 to mark the ticket 20 as used.

Similarly to the operator reports, the ticket distribution system 10 provides for the production of vendor reports and clearinghouse reports containing relevant information about each. A vendor report may contain such information as a list of vouchers scanned by each operator 12 for each event, which can be used to predict payments due from the vendor 14 to the operator 12. A clearinghouse report may include a list of all of the XML calls received in a given time period by caller, a summary of future fees to be received by the clearinghouse 16 in a given time period, and billing reports similar to the operator billing reports described above. Another clearinghouse report is a nightly batch report, which is run every night and emailed to every administrator in the clearinghouse 16. The nightly batch reports are useful in handling automatic financial charging between the operators 12, vendors 14, and the clearinghouse 16, as described below. Additionally, the clearinghouse should have the ability to produce a clearinghouse report containing the same information as any operator report or vendor report.

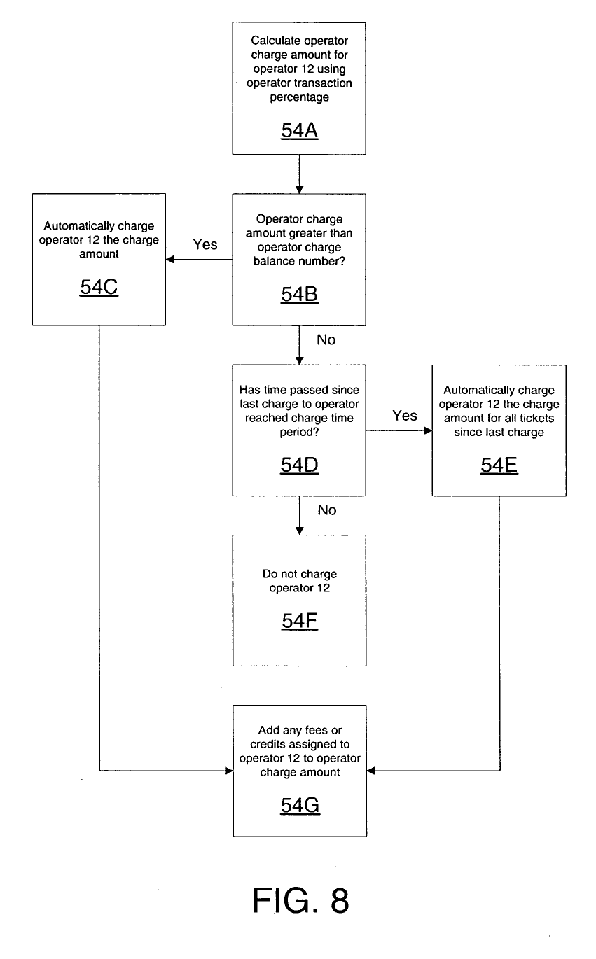

The ticket distribution system 10 also provides a method for automatically charging operators 12 and vendors 14 transaction fees for funds due to the clearinghouse, using a nightly batch processing procedure. First, the operators 14 are processed to determine whether each operator will receive a charge for the batch, as described in the flowchart in FIG. 8, using the charge balance number, charge time period, and transaction percentage described above and contained within the operator account information 36. For each operator 12, the total sum of issued prices of all tickets 20 that are scheduled or expected to be scanned at the operator 12 on the present date, multiplied by the operator's transaction percentage, is calculated at step 54A, called the operator charge amount. Alternately, if a flat fee is used instead of a transaction percentage, the operator charge amount is calculated based on the flat fee per transaction. The operator charge amount is then compared to the charge balance number at step 54B. If the operator charge amount is greater than the charge balance number in the operator account, the operator 12 will be charged, at step 54C. If not, the clearinghouse central computer 30 will analyze the time period passed since the last charge at step 54D. If the time passed since the last charge to the operator 12 has reached the charge time period, the operator 12 will be charged, at step 54E. If so, then the operator charge amount is calculated using the issued price of all tickets 20 with expected scan dates between the last charge to the operator 12 and the present date. If not, then the operator 12 will not be charged, at step 54F. In either case, if the operator 12 is to be charged, the charge amount is adjusted by any pending additional fees or credits assigned to the operator at step 54G.

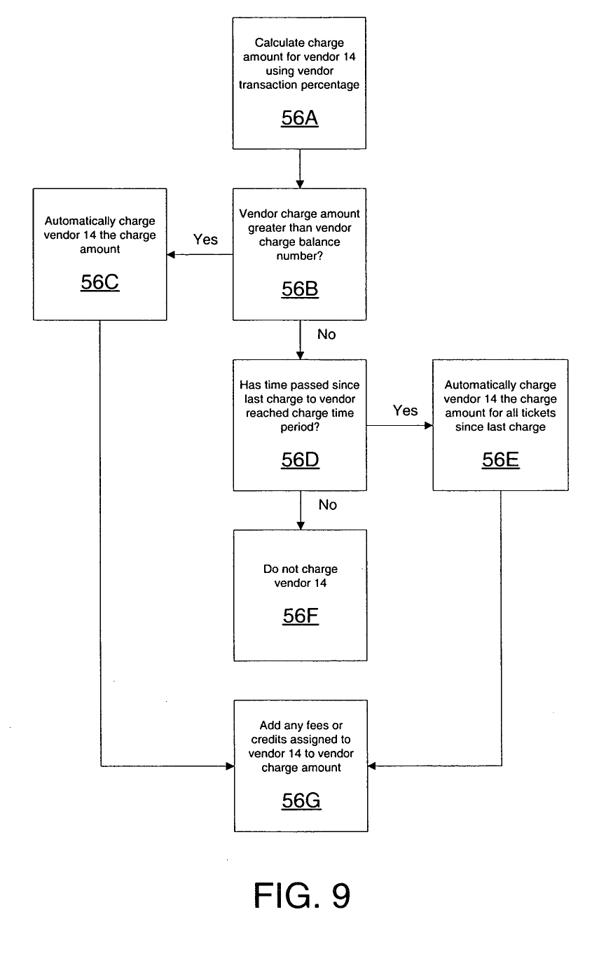

Second, the vendors 14 are processed to determine whether each vendor 14 will receive a charge for the batch, as described in the flowchart in FIG. 9, using the charge balance number, charge time period, and transaction percentage described above and contained within the vendor account information 37. For each vendor, the total sum of the issued prices of all the tickets 20 issued by the vendor 14 with an issue date on the present date, multiplied by the vendor's transaction percentage, is calculated at step 56A, called the vendor charge amount. Alternately, if a flat fee is used instead of a transaction percentage, the operator charge amount is calculated based on the flat fee per transaction. The vendor charge amount is then compared to the charge balance number at step 56B. If the vendor charge amount is greater than the charge balance number in the vendor account, the vendor 14 will be charged, at step 56C. If not, the clearinghouse central computer 30 will analyze the time period passed since the vendor's last charge amount at step 56D. If the time passed since the last charge to the vendor 14 has reached the charge time period, the vendor 14 will be charged, at step 56E. If so, then the vendor charge amount is calculated using the issued price of all tickets 20 issued since the last charge to the vendor 14. If not, then the vendor 14 will not be charged, at step 56F. In either case, if the vendor 14 is to be charged, the charge amount adjusted by any pending additional fees or credits assigned to the vendor 14, such as NSF fees or return fees or credits, at step 56G.

Additionally, the ticket distribution system 10 calculates any NSF fees due from each operator 12 and vendor 14. For each vendor 14 and operator 12 charged, the amount charged and the success or failure of the charge is recorded. For any declined or failed charges, the clearinghouse central computer 30 looks up the NSF fee in the operator account information or vendor account information and adds the NSF fee to the pending charges for the operator 12 or vendor 14. The charges due are then attempted to be charged to the operator 12 or vendor 14 on the next day. The clearinghouse central computer 30 also generates an automatic email to all administrators for each operator 12 or vendor 14 charged with an NSF fee informing of the failed charge and the fee.

The results of all these batch processing procedures are included in the nightly batch report for the clearinghouse 16, which, as described above, is emailed to all clearinghouse administrators. Any time batch processing fails to run completely for one or more days, the ticket distribution system 10 properly accounts for and accommodates any charges or credits to vendors 14 or operators 12 that should have run. Thus, the overall totals are correct the next time batch processing is successfully run.

Finally, the operator 12 and the vendor 14 may handle charges between each other according to the fee arrangement reached. Typically, the vendor 14 will receive money from the customer 18 and will cut checks to the operator 12 periodically, after subtracting any transaction charges due from the operator 12 to the vendor 14.

Charging done in connection with the ticket distribution system 10 typically uses industry-standard tools and procedures for charging operator 12 and vendor 14 accounts, such as third-party software. Such charging should follow industry best practices for security measures.

The ticket distribution system 10 provides advantageous marketing and sales opportunities for both operators 12 and vendors 14. Operators 12 can use a large number of vendors 14, including large retail travel websites, to distribute tickets 20 to their events to a larger number of people over a broader geographical area. Vendors 14 are able to offer a larger number of products to better satisfy their customers. Additionally, the connection from the operator computer 24 to the clearinghouse central computer 30 to check ticket authenticity allows tickets to be sold through the ticket distribution system 10 up until, or possibly even after, the start time of the event. Prior ticket distribution systems that use batch processing for authenticity checks do not provide for authentication of tickets purchased after the last batch is delivered to the operator 12. Still other advantages are provided.

Any process descriptions or blocks in figures, such as FIGS. 6-9, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

While the specific embodiments have been illustrated and described, numerous modifications come to mind without significantly departing from the spirit of the invention, and the scope of protection is only limited by the scope of the accompanying Claims.

What is claimed is:

1. A method for distributing event tickets for events operated by a restrictive plurality of operators ordered through a retail travel website, the method comprising the steps of:
providing for receiving operator account information for each of the plurality of operators to establish an operator account for each of the plurality of operators at a clearinghouse central computer;
providing for receiving event information for each of the events from the operators at the clearinghouse central computer;
providing for making available the event information from the clearinghouse central computer;
providing for receiving a purchase request to purchase a event ticket at the retail travel website;
providing for transmitting an electronic communication to a customer client computer, wherein the electronic communication produces a printable encoded electronic event ticket;
providing for printing the printable encoded electronic event ticket at the customer client computer to create a printed event ticket;
providing for scanning a printed encoded portion of the printed event ticket at an event location associated with the event ticket;
providing for receiving an authenticity request to validate the authenticity of the printed event ticket at the clearinghouse central computer; and
providing for identifying the event ticket as used in the clearinghouse central computer to prevent the event ticket from being used again.

2. The method of claim 1, further comprising the step of providing for transmitting an invoice report in connection with the event ticket from the clearinghouse central computer.

3. The method of claim 1, further comprising the steps of:
providing for calculating a charge amount due to the clearinghouse from the operator based on a ticket price charged for the event ticket; and
providing for generating an automatic debit against the operator account corresponding to the charge amount.

4. The method of claim 1, further comprising the step of providing for paying to the operator associated with the event ticket a portion of proceeds received as a result of the purchase request.

5. The method of claim 1, further comprising the steps of:
providing for transmitting the event information from the clearinghouse central computer to the retail travel website;
providing for transmitting the event information from the clearinghouse central computer from the retail travel website to the customer client computer;
providing for transmitting the purchase request from the customer client computer to the retail travel website; and
providing for transmitting the purchase request from the retail travel website to the clearinghouse central computer.

6. The method of claim 1, further comprising the step of providing for making available the event information from the clearinghouse central computer to a plurality of retail travel websites.

7. The method of claim 1, wherein the event information comprises at least one of event title information, event admission policy information, ticket price information, ticket availability information, event date/time information, event description information, event location information, seating information, illustrative or promotional photographs or logos, and any special information or instructions.

8. The method of claim 1, further comprising the step of providing for receiving payment at the retail travel website in connection with the purchase request.

9. The method of claim 1, wherein the operator account information comprises at least one of operator name information, operator location information, operator financial information, user identification information, operator contact information, and operator description information.

10. The method of claim 1, wherein the step of providing for making available the event information comprises the steps of:
providing for creating a database of event information at the clearinghouse central computer; and
providing for permitting access to the database by the retail travel website via XML interface.

11. A system for interaction with an event operator and a retail travel website, the event operator operating an event and having an operator computer, and the retail travel website having a vendor computer, the system comprising:
a clearinghouse central computer in communication with the operator computer, the vendor computer, and at least one customer client computer, the clearinghouse central computer having a memory containing an operating system and a clearinghouse system, the clearinghouse system comprising:
a first code segment for receiving operator account information for the event operator to establish an operator account for the event operator;
a second code segment for receiving vendor account information for the retail travel website to establish a vendor account for the retail travel website;
a third code segment for making available event information about the event to the retail travel website;
a fourth code segment for receiving a purchase request to purchase an event ticket for admission to the event;
a fifth code segment for transmitting an electronic communication to the customer client computer, wherein the electronic communication produces an encoded electronic event ticket, and wherein the encoded electronic event ticket is printable to create a printed event ticket;
a sixth code segment for receiving an authenticity request from the event operator to validate the authenticity of the printed event ticket;
a seventh code segment for transmitting a validation signal to the event operator if the printed event ticket is valid; and
an eighth code segment for identifying the event ticket as used to prevent the event ticket from being used again.

12. The system of claim 11, wherein the event is a tour event, and the event operator is a tour event operator.

13. The system of claim 11, wherein the computer is further connected to a plurality of event operators, each operating an event, and a plurality of retail travel websites, and the third code segment further makes available event information about the event operated by each of the plurality of event operators to the plurality of retail travel websites.

14. The system of claim 11, wherein the event information comprises at least one of event title information, event admission policy information, ticket price information, ticket availability information, event date/time information, event description information, event location information, seating information, illustrative or promotional photographs or logos, and any special information or instructions.

15. The system of claim 11, wherein the clearinghouse system further comprises a ninth code segment for mating the event operator with the retail travel website through the clearinghouse central computer, wherein a rate structure is defined between the retail travel website and the event operator.

16. The system of claim 11, wherein the clearinghouse system further comprises a ninth code segment for calculating a charge amount to be charged to the event operator and a charge amount to be charged to the retail travel website, based on a ticket price charged for the event ticket.

17. The system of claim 16, wherein the clearinghouse system further comprises a tenth code segment for generating an automatic debit against the operator account corresponding to the charge amount.

18. A method for operating a clearinghouse, having a clearinghouse central computer, for distributing event tickets for an event operated by an operator and ordered through a retail travel website, the method comprising the steps of:
receiving operator account information for the operator to establish an operator account for the operator;
making available event information about the event to the retail travel website;
receiving a purchase request to purchase an event ticket;
transmitting an electronic communication to a customer client computer, wherein the electronic communication produces an encoded electronic event ticket, and wherein the encoded electronic event ticket is printable to create a printed event ticket;
receiving an authenticity request from the operator to validate the authenticity of the printed event ticket;
transmitting a validation signal to the operator if the printed event ticket is valid; and
identifying the event ticket as used to prevent the event ticket from being used again.

19. The method of claim 18, further comprising the step of calculating a charge amount due to the clearinghouse from the operator based on a ticket price charged for the event ticket.

20. The method of claim 19, further comprising the step of generating an automatic debit against the operator account corresponding to the charge amount.
